(19) United States
(12) Patent Application Publication
(10) Pub. No.: US 2022/0041200 A1
(43) Pub. Date: Feb. 10, 2022

(54) ELECTRIC MOTOR DESIGNED FOR DRIVING A VEHICLE WHICH CAN BE MOVED BY A PERSON

(71) Applicant: Robert Bosch GmbH, Stuttgart (DE)

(72) Inventors: Norbert Martin, Achern (DE); Barbara Juengling, Muggensturm (DE); Ester Ruprecht, Offenburg (DE); Pierre Nonnenmacher, Minversheim (FR)

(21) Appl. No.: 17/276,629

(22) PCT Filed: Jul. 22, 2019
(86) PCT No.: PCT/EP2019/069657

§ 371 Date: Mar. 16, 2021

(30) Foreign Application Priority Data
Sep. 17, 2018 (DE) 10 2018 215 750.2

(51) Int. Cl. B62B 5/00; B62B 7/04

(52) U.S. Cl. CPC B62B 5/0043; B62B 5/0069; B62B 7/04

(57) ABSTRACT

The invention relates to an electric motor (24) designed for driving a vehicle (10) which can be moved by a person, particularly a pram (11), walker or the like, having a rotor (52), which comprises at least one holder (80) for a wheel (14, 16), and a stator (54) which can be connected through a housing (38) to a load-bearing structure (12) of the vehicle (10). According to the invention, the housing (38) has a status display (84) on which parameters, particularly power parameters, of the electric motor (24) can be displayed so as to be visible from the outside.

### BACKGROUND

The invention relates to an electric motor that is configured so as to drive a vehicle which can be moved by a person, in particular a baby carriage, a walking frame or the like, having a rotor, which comprises at least one receiving device for a wheel, and a stator that can be connected to a load-bearing structure of the vehicle by way of a housing.

DE 102013224885 A1 discloses a baby carriage that can be driven by an electric motor.

### SUMMARY

The electric motor in accordance with the invention and characterized itself in addition by virtue of the fact that the housing comprises a status indicator by way of which the parameters, in particular power parameters, can be displayed in an externally visible manner comprises the advantage that the operator of the baby carriage is constantly informed about the operating state of said baby carriage. The phrase “in an externally visible manner” is to be understood to mean that the status indicator is visible when looking at the housing.

Advantageous developments of the electric motor in accordance with the invention are possible by virtue of the features disclosed in the subordinate claims. The space that is offered by the housing is thus optimally utilized if the status indicator is adapted to suit the housing, in particular extends along the surface of the housing.

A simple and modern status indicator comprises one or more light-emitting diodes that emit light outwards directly or by way of at least one light conductor.

A simple construction is created if the status indicator comprises segments that are distributed over the housing surface.

In an advantageous manner, the status indicator is arranged on an axial wall of the housing.

A further simple construction is created that also meets the esthetic requirements if the status indicator is arranged in an annular manner on a circumference and/or a sector of the housing.

An implementation of the invention is realized, if at least one control unit is provided that determines a prevailing status from the parameters, in particular from the power parameters, stores said prevailing status in particular in a storage device and controls the status indicator according to the information obtained.

The most important information is output if the status indicator comprises at least one region that displays information regarding the wheel rotational speed, a speed and/or an effective torque.

Values of the parameters, in particular power parameters, can be displayed in a particularly simple manner by means of a light intensity and/or color of the status indicator.

The parameters, in particular power parameters, can also be displayed by means of chronological sequences of light signals of the status indicator.

### BRIEF DESCRIPTION OF THE DRAWINGS

The drawing illustrates exemplary embodiments of the electric motor in accordance with the invention in one application and described in detail in the description below. In the drawing:

FIG. 1 illustrates a schematic view of a baby carriage,

FIG. 2 illustrates a perspective view of a drive unit having an electric motor in accordance with the invention,

FIG. 3 illustrates a schematic sectional view of an electric motor,

FIG. 4 illustrates a first exemplary embodiment for an electric motor having a status indicator,

FIG. 5 illustrates a perspective view of a further exemplary embodiment for an electric motor having a status indicator and

FIGS. 6 to 8 illustrate further exemplary embodiments in a side view.

### DETAILED DESCRIPTION

Like parts are provided in the description and in the figures with like reference numerals even in the case of different exemplary embodiments.

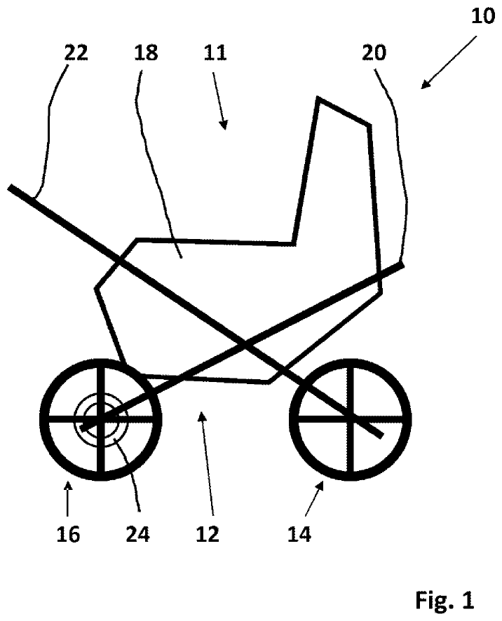

FIG. 1 illustrates a schematic side view of a vehicle 10 in the embodiment of a baby carriage 11. Fundamentally, the baby carriage 11 comprises a load-bearing structure 12, front wheels 14, rear wheels 16 and a receiving shell 18. The load-bearing structure 12 comprises load-bearing bars 20 and push bars 22. An electric motor 24 is attached at least to a rear wheel. Further conventional components, such as holders, springs or closures, are not illustrated.

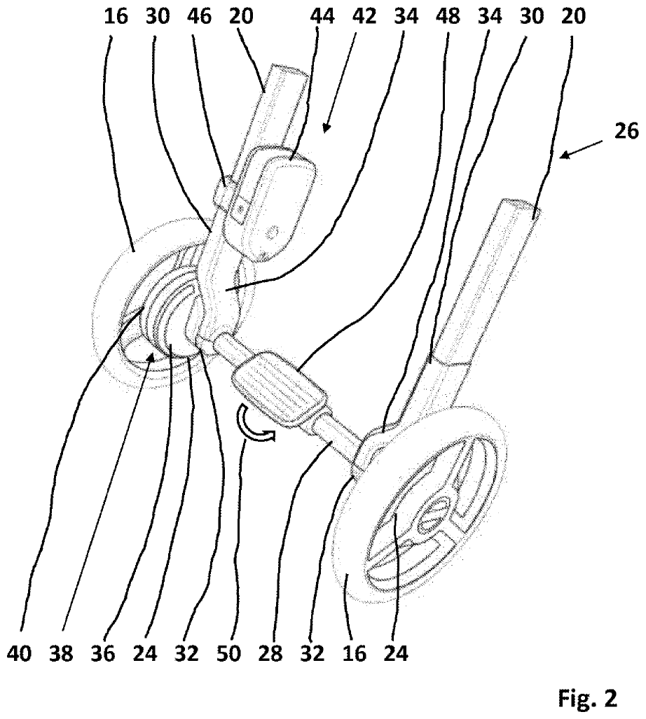

The drive unit 26 that is illustrated in FIG. 2 illustrates the rear wheels 16 and the load-bearing bars 20 of the baby carriage 11 that is illustrated schematically in FIG. 1. The drive unit 26 comprises a cross member 28 that connects the two rear wheels 16 to one another. The two load-bearing bars 20 are fastened to this cross member 28. For this purpose, the drive unit 26 comprises fastening domes 30 that suitably engage around the load-bearing bars 20. The fastening domes 30 are connected to the cross member 28 by way of screw connections 32. The fastening domes 30 have bends 34 for receiving the electric motor 24.

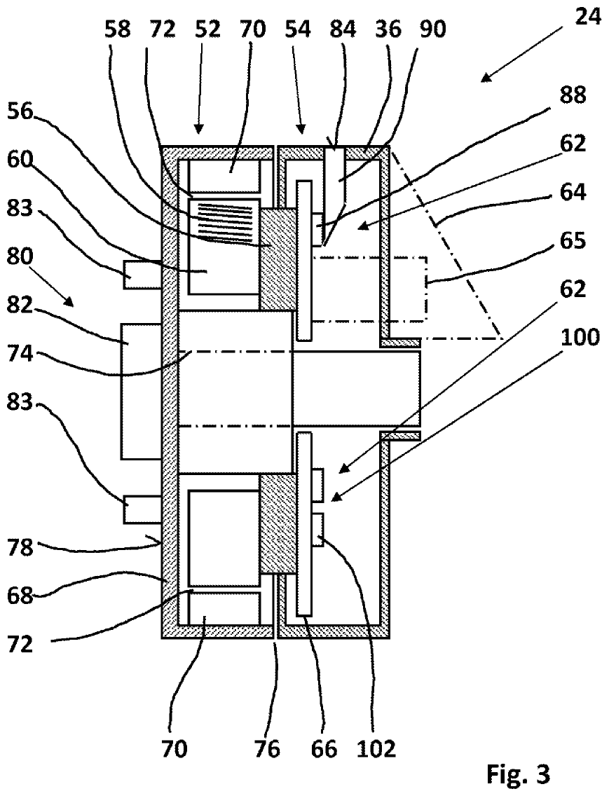

The cross member 28 issues with its end into the electric motor 24 and is connected at this site to a first housing part 36 of a housing 38 of the electric motor 24. One of the rear wheels 16 is fastened in the axial extension to a second housing part 40 of the housing 38. The construction of the electric motor 24 is described later with the aid of FIG. 3.

An energy supply unit 42 is attached at the upper end of one of the fastening domes 30. This energy supply unit is connected to the electric motor 24 by means of a cable (not illustrated). The energy supply unit 42 comprises a housing 44 that is fastened to the fastening dome 30 by means of a collar 46. A rechargeable battery is accommodated in the housing 44 of the energy supply unit 42.

It is also possible in lieu of a housing 44 to provide a receiving shell for a rechargeable battery and a rechargeable battery can be inserted directly into said receiving shell. It is likewise also possible to fasten the housing 44 or a receiving shell for a rechargeable battery to the load-bearing bar 20. Also alternative mounting sites for the energy supply unit 42 are possible depending upon the configuration and equipment of the vehicle 10.

The drive unit 26 is equipped in the exemplary embodiment with two electric motors 24 that are synchronized by way of a cable that preferably runs in the cross member 28. However, it is also possible to provide only one electric motor 24 and to guide a drive shaft in the cross member 28 to the other rear wheel 16.

A pedal 48 is arranged on the cross member 28 and said pedal depending upon its configuration can output control commands to the electric motor 24 and/or the energy supply unit 42. In the exemplary embodiment, it is possible for the pedal 48 when more heavily actuated, in other words when more heavily pivoted in the direction of the arrow 50 to activate a mechanical brake or locking brake.

The electric motor 24 that is illustrated in FIG. 3 is characterized by means of an axial construction comprising a rotor 52 and a stator 54, which are embodied as load-bearing or supporting components.

The stator 54 has a base plate 56, to which is attached a coil body 60 that supports coils 58. A coil 58 is illustrated schematically. The coil body 60 can also directly assume a load-bearing function with the result that it is possible to forego a separate base plate 56.

The first housing part 36 is fastened to the base plate 56. The first housing part 36 that is illustrated in FIG. 3 as a closed housing can also be constructed from multiple parts in order to ensure access to the components 62 that are arranged in the first housing part 36. Generally, the first housing part 36 is configured in a water-tight manner in order to protect the components 62 accommodated therein. In one exemplary embodiment (not illustrated), the base plate 56 can be embodied as the first housing part 36 or to a great extent assume the function of said first housing part. Likewise, it is possible for parts of the stator 54 to be embodied in the form of a housing.

In order to be able to receive large components 62, the first housing part 36 can be configured enlarged in regions, as is illustrated in FIG. 3 by the dot-dash hood 64. Such components 62 can be for example male plug receiving devices 65 or capacitors.

A printed circuit board 66 is arranged on the base plate 56 and said printed circuit board receives the already mentioned components 62 that lie therein and connects said components in an electrical circuit.

The rotor 52 forms a second housing part 68 that receives the magnets 70 in such a manner that they lie opposite the coils 58. The rotor 52 is embodied as a so-called external rotor. In this case, the magnet 70 are arranged in such a manner that they can rotate about the coils 58, separated only by a small air gap 72 from the coils 58 that face outwards. For this purpose, the rotor 52 is mounted by way of a bearing 74 on the stator 54 or in the exemplary embodiment on the base plate 56.

The bearing 74 is embodied in such a manner that the rotor 52 can rotate free of play and is also held in an axial manner in narrow tolerances relative to the stator.

A narrow gap 76 remains between the first housing part 36 and the second housing part 68 in FIG. 3. This narrow gap can be sealed in an alternative embodiment by way of a labyrinth seal, a synthetic material contact seal or the like.

The rotor 52 comprises on an outer-lying side 78 receiving devices 80 by way of which the rear wheels 16 can be connected in a non-rotatable manner to the rotor 52. The receiving devices 80 are part of the second housing part 68 and are divided into a centering hub 82 and an entrainer 83.

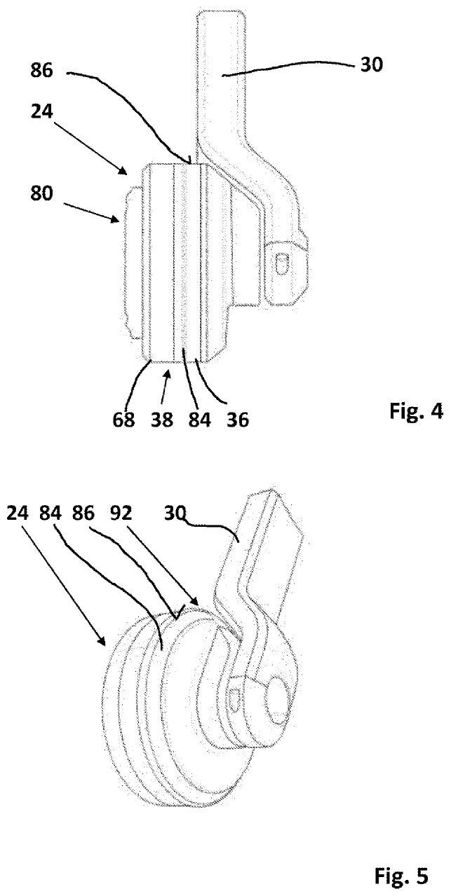

FIG. 4 illustrates the electric motor 24 having the housing 38. The housing 38 comprises a status indicator 84 by means of which it is possible to display parameters of the electric motor in an externally visible manner. The parameters displayed are generally in particular power parameters relating to the electric motor 24, power parameters relating to the energy supply unit 42 and/or activities data of the vehicle.

As is apparent in FIG. 4, the status indicator 84 is adapted to suit the housing form of the housing 38. It extends in particular along the outer housing structure. By virtue of arranging the status indicator 84 in the region of the electric motor 24, it is possible to maintain this as a replaceable unit.

In the exemplary embodiment, the status indicator unit 84 is adapted to suit the housing form. It is embodied extended lengthwise, narrow and flush with the surface 86 of the first housing part 36. Since it follows the cylindrical housing form of the electric motor 24, the status indicator in this exemplary embodiment is arranged in an annular manner on the circumference of the housing. As a consequence, a clearly visible display is provided that always imparts information regarding the most important parameters. The simplicity of said display also meets the esthetic requirements.

In one embodiment, the status indicator 84 comprises a light-emitting diode 88. As is particularly apparent in FIG. 3, the light-emitting diode 88 is located directly on the printed circuit board 66. The light that is emitted by said light-emitting diode is coupled to a light conductor 90 that guides the light to the surface 86. Different display forms and areas can be produced on the surface 86 by way of such light conductors 90.

However, it is also possible to arrange the light-emitting diodes 90 in such a manner that they lie directly on a surface 86 of the housing 38 and consequently can emit light outwards directly.

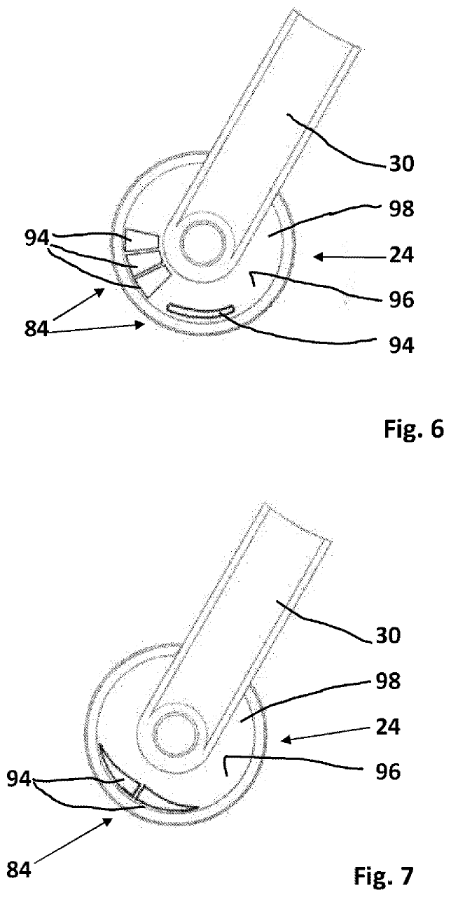

In the exemplary embodiment according to FIG. 5, the status indicator 84 is arranged on a sector 92 of the housing 38. A sector is understood to be an oblique region. The status indicator 86 can be arranged along this complete sector 92. However, in the exemplary embodiment interrupted in the region of the load-bearing arm 20.

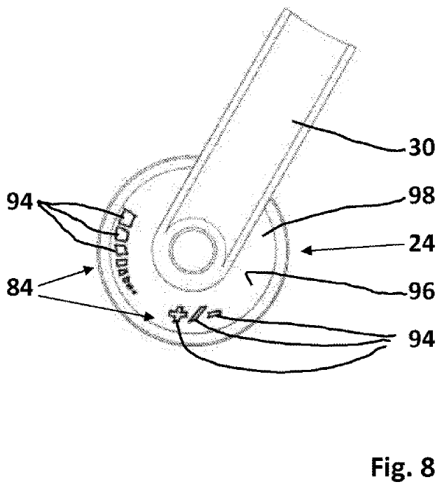

In the further exemplary embodiments according to FIGS. 6 to 8, different embodiments of the status indicator 86 are illustrated. Thus, the status indicator 86 according to FIG. 6 demonstrates individual segments 94. These are distributed along the surface 96. They are adapted to suit the surface 96 in such a manner that they assume its circular ring shape and are likewise arranged adjacent to one another in a circular ring shape. It is apparent in FIG. 6 that the segments 94 can comprise a different area expansion. Thus, they can be of have a sector character or can also comprise the section of a circular ring extended lengthwise.

In FIG. 6, the segments 94 are arranged on an axial wall 98. Consequently, they face into an inner region of the drive unit 26 and are therefore at least in part hidden from the environment. The status indicator 84 is primarily visible to the person operating the vehicle 10.

Naturally segment-like status indicators 84 can also be arranged on the circumference of the housing 38. The choice which type the form of the status indicator 84 has depends in particular on the parameters that are to be displayed.

FIG. 7 illustrates an exemplary embodiment of a status indicator 84 that has a tapering shape. Since it is arranged in an axial manner, it has a corresponding circular shape. By virtue of the tapering contour, it is possible to output a relative value of a parameter from large to small. It is necessary for this purpose that different light-emitting elements are arranged over the longitudinal extension of the status indicator 84 with the result that the relative value can be determined based on the position of said light-emitting elements.

FIG. 8 illustrates a status indicator 84 similar to the one in FIG. 7 but divided into segments. It is apparent that it is of advantage here if one light-emitting diode 88 is provided for each segment. This can be arranged directly below the segment 94 or however connected to the segment 94 in each case by way of a light conductor 90.

Furthermore, FIG. 8 illustrates that symbols can also be used as a status indicator 84. Not illustrated but possible are segments that output the absolute number or a measurement unit.

The printed circuit board 66 illustrated in FIG. 3 and arranged in the electric motor 24 and accommodates a circuit that comprises a control unit 100. This control unit controls the activity of the electric motor 24 depending upon actions performed by the person operating the vehicle. This can be for example accelerating the vehicle, braking the vehicle, reversing the vehicle or an equivalent assist or an assist that is adapted for negotiating curves. The parameters, in particular power parameters, that are required for the prevailing status are determined. This is to be understood to mean that for example the current values that are output to the coils 58 are taken into consideration directly or as mean values. These are then stored in a storage device 102 and can be used for the status indicator 84 by way of an information output. The light-emitting diode or light-emitting diodes 88 of the status indicator 84 are controlled accordingly by the control unit 100.

In addition to the already mentioned current values, suitable parameters for display are also the prevailing wheel rotational speed, a speed that is derived therefrom and/or an effective torque. It is clear that the parameters that are to be displayed are taken into account when configuring the status indicator 84.

In one exemplary embodiment, it is provided that the value of the parameters is accentuated by means of the light intensity of the status indicator 84. The higher the value, the brighter the setting of the associated light-emitting diode 88. In the exemplary embodiment, it is also provided that values of the parameters are displayed by means of the color of the status indicator 84. This is realized in the exemplary embodiment according to FIG. 8 by virtue of the fact that light-emitting didoes 88 having different colors are allocated to the individual segments. In another embodiment, it is also possible to allocate a light-emitting diode 88 to a segment 94, which renders it possible to adjust the color or frequency of said light-emitting diode.

Moreover, it is possible for the parameters to be displayed by means of chronological sequences of light signals of the status indicator 84. For this purpose, for example an increasing wheel rotational speed or speed is displayed by means of a light-emitting diode 88 flashing rapidly. Furthermore, error states can also be displayed by means of the light-emitting diode 88 flashing in an appropriate manner.

The status indicators 84 that are illustrated in the different figures can be combined with one another. This means that status indicators 84, which are arranged over the circumference of the housing 38, are combined with those that are arranged on an axial surface. Moreover, status indicators 84 that are distributed over the circumference can comprise segment structures or symbols.

In addition to the rear wheel 16, one or both front wheels 14 can also be driven alternatively to the rear wheels 16 or in combination therewith. The electric motor 24 would then comprise a status indicator 84 that would not be optimally visible to the person operating the vehicle.

1. An electric motor (24), configured to drive a vehicle (10) that can be moved by a person, the electric motor (24) having a rotor (52), which comprises at least one receiving device (80) for a wheel (14, 16), and a stator (54) that can be connected to a load-bearing structure (12) of the vehicle (10) by way of a housing (38), characterized in that the housing (38) comprises a status indicator (84) by way of which parameters of the electric motor (24) can be displayed in an externally visible manner.

2. The electric motor (24) as claimed in claim 1, characterized in that the status indicator (84) is configured to suit the housing form extends along a surface (96).

3. The electric motor (24) as claimed in claim 1, characterized in that the status indicator (84) comprises one or more light-emitting diodes (88) that emit light outwards directly or by way of light conductors (90).

4. The electric motor (24) as claimed in claim 1, characterized in that the status indicator (84) comprises segments (94) that are distributed over a housing surface (96).

5. The electric motor (24) as claimed in claim 1, characterized in that the status indicator (84) is arranged on an axial wall (98) of the housing (38).

6. The electric motor (24) as claimed in claim 1, characterized in that the status indicator (84) is arranged in an annular manner on a circumference and/or a sector (92) of the housing (38).

7. The electric motor (24) as claimed in claim 1, characterized in that at least one control unit (100) is provided that determines a prevailing status from the parameters, stores said prevailing status in a storage device (102) and controls the status indicator (84) according to information obtained.

8. The electric motor (24) as claimed in claim 1, characterized in that the status indicator (84) comprises at least one region that displays information regarding a wheel rotational speed, a speed and/or an effective torque.

9. The electric motor (24) as claimed in claim 1, characterized in that a value of the parameters is displayed by means of a light intensity and/or color of the status indicator (84).

10. The electric motor (24) as claimed in claim 1, characterized in that the parameters are displayed by chronological sequences of light signals of the status indicator (84).

11. The electric motor (24) as claimed in claim 1, characterized in that the electric motor (24) is configured to drive a baby carriage (11), a walking frame or the like.

12. The electric motor (24) as claimed in claim 1, characterized in that the parameters of the electric motor (24) are power parameters.
